(19) United States
(12) Patent Application Publication
(10) Pub. No.: US 2015/0169146 A1
(43) Pub. Date: Jun. 18, 2015

(54) APPARATUS AND METHOD FOR SWITCHING APPLICATIONS ON A MOBILE TERMINAL

(71) Applicant: Samsung Electronics Co., Ltd., Suwon-si (KR)

(72) Inventor: Saurabh LALWANI, San Jose, CA (US)

(73) Assignee: Samsung Electronics Co., Ltd., Suwon-si (KR)

(21) Appl. No.: 14/105,822

(22) Filed: Dec. 13, 2013

(51) Int. Cl. G06F 3/0482; G06F 3/0481

(52) U.S. Cl. CPC G06F 3/0482; G06F 3/04817

(57) ABSTRACT

An apparatus and method for switching among applications are provided. The method includes detecting an input to activate an application switcher functionality, upon detecting the input to activate the application switcher functionality, displaying at least one application switcher menu, detecting an input corresponding to a request to expand one of the at least one application switcher menus, and expanding the one of the at least one application switcher menus according to the detected request to expand the one of the at least one application switcher menus. Each of the at least one application switcher menus may include at least one application icon associated with an application belonging to a category to which the application switcher menu relates.

### TECHNICAL FIELD

The present disclosure relates to an apparatus and method for switching among applications operating on a mobile terminal. More particularly, the present disclosure relates to an apparatus and method for displaying an application switcher menu to enable a user to switch among applications operating on a mobile terminal.

### BACKGROUND

Mobile terminals are developed to provide wireless communication between users. As technology has advanced, mobile terminals now provide many additional features beyond simple telephone conversation. For example, mobile terminals are now able to provide additional functions such as an alarm, a Short Messaging Service (SMS), a Multimedia Message Service (MMS), E-mail, games, remote control of short range communication, an image capturing function using a mounted digital camera, a multimedia function for providing audio and video content, a scheduling function, and many more. With the plurality of features now provided, a mobile terminal has effectively become a necessity of daily life.

According to the related art, a mobile terminal may have a functionality for switching among recently used applications. The functionality for switching among recently used applications may be an application switcher menu which may be displayed upon detection of a predefined input.

FIG. 1 is a diagram illustrating an application switcher menu according to the related art.

Referring to FIG. 1, a mobile terminal 100 may display an application switcher menu 120 on the display 110. The application switcher menu 120 may include at least one application icon 121a corresponding to a recently used application. The application switcher menu 120 may also display a single row of a plurality of application icons 121a, 121b, 121c, 121d, 121e, 121f, and 121g each of which corresponds to a recently used application.

Accordingly, there is a need for an apparatus and method for providing an improved user interface while reducing power consumption in a mobile terminal

### SUMMARY

Aspects of the present disclosure are to address at least the above-mentioned problems and/or disadvantages and to provide at least the advantages described below. Accordingly, an aspect of the present disclosure is to provide an apparatus and method for switching among applications.

In accordance with an aspect of the present disclosure, a method for switching among applications on a mobile terminal is provided. The method includes detecting an input to activate an application switcher functionality, upon detecting the input to activate the application switcher functionality, displaying at least one application switcher menu, detecting an input corresponding to a request to expand one of the at least one application switcher menus, and expanding the one of the at least one application switcher menus according to the detected request to expand the one of the at least one application switcher menus. Each of the at least one application switcher menus may include at least one application icon associated with an application belonging to a category to which the application switcher menu relates.

In accordance with another aspect of the present disclosure, an apparatus for apparatus for switching among applications is provided. The apparatus includes a display unit, an input unit, and a control unit configured to detect an input to the input unit to activate an application switcher functionality, to control the display unit to display, upon detection of the input to activate the application switcher functionality, at least one application switcher menu, to detect an input corresponding to a request to expand one of the at least one application switcher menus, and to control the display unit to display one of the application switcher menus in expanded form according to the detected expand the one of the at least one application switcher menus. Each of the at least one application switcher menus may include at least one application icon associated with an application belonging to a category to which the application switcher menu relates.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of various embodiments of the present disclosure will be more apparent from the following description taken in conjunction with the accompanying drawings, in which:

FIG. 1 is a diagram illustrating an application switcher menu according to the related art;

FIG. 2 is a diagram illustrating an application switcher menu according to various embodiments of the present disclosure;

FIG. 3 is a diagram illustrating an application switcher menu according to various embodiments of the present disclosure;

FIG. 4 is a flowchart illustrating a method for switching among applications operating on a mobile terminal according to various embodiments of the present disclosure; and

FIG. 5 is a block diagram schematically illustrating a configuration of a mobile terminal according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the present disclosure are provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As a non-exhaustive illustration only, a terminal described herein may refer to mobile devices such as a cellular phone, a Personal Digital Assistant (PDA), a digital camera, a portable game console, an MP3 player, a Portable/Personal Multimedia Player (PMP), a handheld e-book, a tablet PC, a portable lap-top PC, a Global Positioning System (GPS) navigation, and devices such as a desktop PC, a high definition television (HDTV), an optical disc player, a set-top box, and the like consistent with that disclosed herein.

Applications are a fundamental element of a mobile terminal. According to modern use of mobile terminals, users use a lot of applications very frequently and also re-open the applications using an application switcher menu. Using the application switcher menu to switch among applications is convenient. However, the convenience of using an application switcher menu to switch among the applications is generally limited to instances in which the user does not have to scroll through applications provided by the application switcher menu.

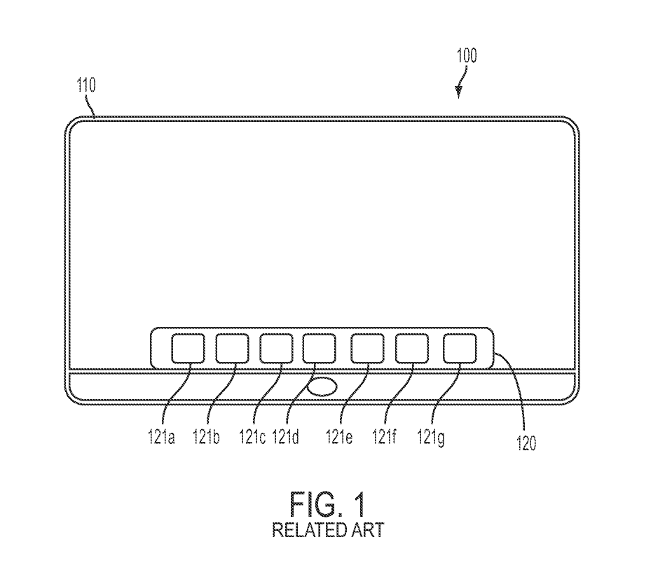

With further reference to FIG. 1, the application switcher menu according to the related art has several limitations. For example, such limitations include: inefficient and ineffective use of the screen space available on the Graphical User Interface (GUI); the application switcher menu merely displays a listing of recently used applications and the list of recently used applications continues to grow over time such that the application switcher menu according to the related art requires a user to scroll through applications provided therein; finding a desired application in the application switcher menu according to the related art can be time consuming; activation of the application switcher menu according to the related art requires use of a dedicated button on the mobile terminal (e.g., a home button on mobile terminals according to the related art); the application switcher menu according to the related art does not make good use of the hardware and software capabilities of modern mobile terminals.

Various embodiments of the present disclosure include an apparatus and method for switching among applications operating on a mobile terminal.

According to various embodiments of the present disclosure, an application switcher menu may be displayed upon input of a predefined input. According to various embodiments of the present disclosure, the predefined input may be configurable by a user and/or manufacturer of the mobile terminal. The predefined input may correspond to a three-finger swipe down gesture on a touch screen, a selected gesture in the form of a letter, a shape, a number, and/or the like, selection of a physical button arranged on the mobile terminal, or the like.

According to various embodiments of the present disclosure, the application switcher menu may display at least one application icon therein.

According to various embodiments of the present disclosure, a plurality of application switcher menus may be on the screen. According to various embodiments of the present disclosure, the plurality of application switcher menus may be displayed such that at least one application switcher menu may be displayed on two different sides of the screen.

According to various embodiments of the present disclosure, four application switcher menus may be displayed on the screen. According to various embodiments of the present disclosure, when four application switcher menus are displayed on the screen, the application switcher menus may be arranged such that an application switcher menu is displayed along the bottom side of the screen, an application switcher menu is displayed along the left side of the screen, an application switcher menu is displayed along the top side of the screen, and an application switcher menu is displayed along the right side of the screen.

According to various embodiments of the present disclosure, each of the plurality of application switcher menus may relate to a different category of applications. According to various embodiments of the present disclosure, the category to which each of the plurality of application switcher menus relates may be configurable by the user and/or manufacturer.

According to various embodiments of the present disclosure, the at least one application icon displayed within the corresponding application switcher menu is associated with the category to which the application switcher menu relates.

According to various embodiments of the present disclosure, a subset of the plurality of application switcher menus may be displayed according to the specific input detected. For example, more than one input may be set to correspond to activate the application switcher functionality, and each of the inputs set to activate the application switcher functionality may load to display a different subset of activation switcher menus.

According to various embodiments of the present disclosure, the application switcher menu may be expanded to display additional application icons associated with the category to which the application switcher menu relates. According to various embodiments of the present disclosure, the application switcher menu may be expanded upon detection of a predefined or set input.

According to various embodiments of the present disclosure, a category of the application switcher menu may be recently used applications, frequently used applications, recently downloaded applications, favorites, and/or the like. According to various embodiments of the present disclosure, a user may configure customized categories. According to various embodiments of the present disclosure, the user may set a set of applications for which the corresponding application switcher menu includes corresponding application icons.

According to various embodiments of the present disclosure, the application switcher functionality may be linked or otherwise associated with a user account. According to various embodiments of the present disclosure, the user account may be a device specific account, or may be an account that may be accessed across a plurality of devices (e.g., a plurality of mobile terminals). According to various embodiments of the present disclosure, the user account may be provided by a cloud-service (e.g., an internet-service, a network-based service, or the like). According to various embodiments of the present disclosure, a user's settings in relation to specific application switcher menus to be displayed, to specific contexts in which a specific application switcher menu is to be displayed (e.g., based on a detected input), to specific contexts in which the mobile terminal is operating (e.g., at work, at home, or the like), to categories to which each application switcher menu relates, to the number of application switcher menus displayed, to the configuration and/or arrangement of the displayed application switcher menus displayed, and/or the like may be stored in association with the user account. According to various embodiments of the present disclosure, the user settings may be automatically applied to the mobile device upon login to the user's account. According to various embodiments of the present disclosure, the user settings may be applied upon user selection to apply that user's settings or preferences associated with the application switcher functionality. According to various embodiments of the present disclosure, the user account may be synced in relation to current and/or saved user settings of the application switcher functionality.

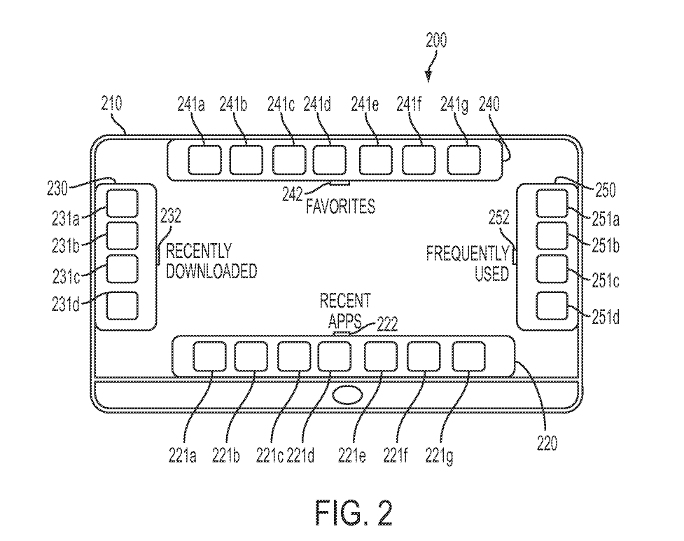

FIG. 2 is a diagram illustrating an application switcher menu according to various embodiments of the present disclosure.

Referring to FIG. 2, a mobile terminal 200 displays a plurality of application switcher menus 220, 230, 240, and 250 on a display 210.

According to various embodiments of the present disclosure, each of the plurality of application switcher menus 220, 230, 240, and 250 has included therein at least one application icon (or item) corresponding to an application (or a file).

According to various embodiments of the present disclosure, a plurality of keys, tabs, or the like (e.g., an icon) may be displayed on the screen. Each of the plurality of keys, tabs, or the like may be associated with one of the plurality of application switcher menus 220, 230, 240, and 250, and may expand the corresponding application switcher menu upon selection of the key, tab, or the like. According to various embodiments of the present disclosure, a key, tab, or the like may be displayed in association with a corresponding application switcher menu if the category to which the specific application switcher relates includes a greater number of applications than the number of application icons that may be displayed in a collapsed view (e.g., when the application switcher menu is not expanded). The collapsed view of an application switcher menu may display one row or one column of application icons.

According to various embodiments of the present disclosure, each of the plurality of application switcher menus 220, 230, 240, and 250, may relate to a different category. The at least one application icon included in each of the plurality of application switcher menus 220, 230, 240, and 250 may be associated with the category to which the corresponding application switcher menu relates.

As illustrated in FIG. 2, the application switcher menu 220 is displayed at the bottom of the screen 210 (e.g., so as to form a horizontal row). The application switcher menu 220 relates to the category recently used applications (e.g., “Recent Apps”). The application switcher menu 220 includes a plurality of application icons 221a, 221b, 221c, 221d, 221e, 221f, and 221g. According to various embodiments of the present disclosure, the application switcher menu 220 may also have a tab 222 associated therewith. Selection of the tab 222 expands the application switcher menu 220. If the application switcher menu 220 is expanded, additional application icons corresponding to the category to which the application switcher menu 220 relates (e.g., recently used applications) may be displayed if the category includes any additional application icons that are not displayed when the application switcher menu 220 is collapsed.

The application switcher menu 230 is displayed at the left of the screen 210 (e.g., so as to form a vertical column). The application switcher menu 230 relates to the category recently downloaded items. The recently downloaded category may correspond to recently downloaded files (e.g., media files, word documents, and the like), recently downloaded applications, and the like, or a combination thereof. The application switcher menu 230 includes a plurality of application icons 231a, 231b, 231c, and 231d. According to various embodiments of the present disclosure, the application switcher menu 230 may also have a tab 232 associated therewith. Selection of the tab 232 expands the application switcher menu 230. If the application switcher menu 230 is expanded, additional application icons corresponding to the category to which the application switcher menu 230 relates (e.g., recently downloaded items) may be displayed if the category includes any additional application icons (or items) that are not displayed when the application switcher menu 230 is collapsed.

The application switcher menu 240 is displayed at the top of the screen 210 (e.g., so as to form a horizontal row). The application switcher menu 240 relates to the category favorites. The favorites category may correspond to items identified by the user as being that user's favorites. The favorite items may correspond to favorite files (e.g., media files, word documents, and the like), favorite applications, and the like, or a combination thereof. The application switcher menu 240 includes a plurality of application icons 241a, 241b, 241c, 241d, 241e, 241f, and 241g. According to various embodiments of the present disclosure, the application switcher menu 240 may also have a tab 242 associated therewith. Selection of the tab 242 expands the application switcher menu 240. If the application switcher menu 240 is expanded, additional application icons corresponding to the category to which the application switcher menu 240 relates (e.g., favorite items) may be displayed if the category includes any additional application icons (or items) that are not displayed when the application switcher menu 240 is collapsed.

The application switcher menu 250 is displayed at the right of the screen 210 (e.g., so as to form a vertical column). The application switcher menu 250 relates to the category frequently used. The frequently used category may correspond to items determined by the mobile terminal over a predetermined time interval (e.g. within the last day, the last week, the last month, or the like). Determination as to whether an application corresponds to a frequently used application may be based on comparing how frequently the application is executed, loaded, or otherwise operated in relation to a preset threshold over a specified time interval. The time interval may be configurable by the user and may be stored as a user preference in association with the user account. The frequently used items may correspond to frequently used files (e.g., media files, word documents, and the like), frequently used applications, and the like, or a combination thereof. The application switcher menu 250 includes a plurality of application icons 251a, 251b, 251c, and 251d. According to various embodiments of the present disclosure, the application switcher menu 250 may also have a tab 252 associated therewith. Selection of the tab 252 expands the application switcher menu 250. If the application switcher menu 250 is expanded, additional application icons corresponding to the category to which the application switcher menu 250 relates (e.g., frequently used items) may be displayed if the category includes any additional application icons (or items) that are not displayed when the application switcher menu 250 is collapsed.

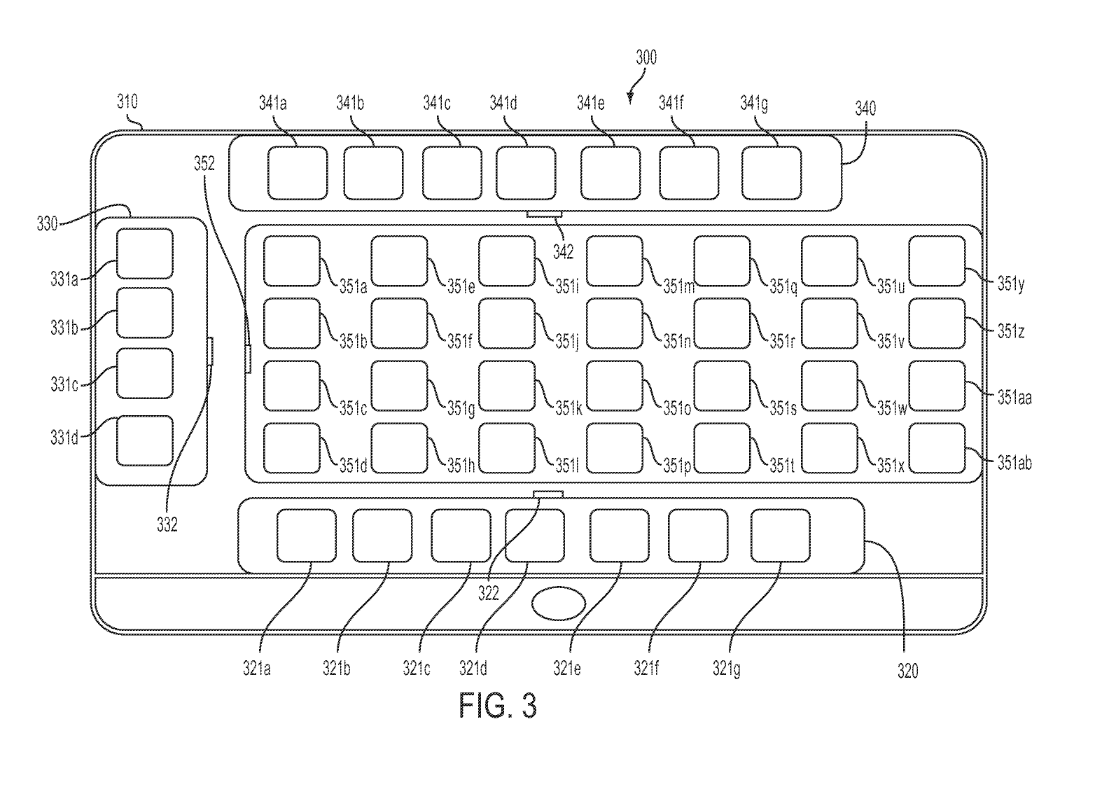

FIG. 3 is a diagram illustrating an application switcher menu according to various embodiments of the present disclosure.

Referring to FIG. 3, a mobile terminal 300 displays a plurality of application switcher menus 320, 330, 340, and 350 on a display 310.

According to various embodiments of the present disclosure, each of the plurality of application switcher menus 320, 330, 340, and 350 has included therein at least one application icon corresponding to an application.

According to various embodiments of the present disclosure, each of the plurality of application switcher menus 320, 330, 340, and 350, may relate to a different category. The at least one application icon included in each of the plurality of application switcher menus 320, 330, 340, and 350 may be associated with the category to which the corresponding application switcher menu relates.

According to various embodiments of the present disclosure, an application switcher menu may be expanded to display additional application icons associated with the category to which the application switcher menu relates. For example, as illustrated in FIG. 3, the application switcher menu 350 is expanded. As an example, the expanded application switcher menu 350 displays additional icons (e.g., in relation to application switcher menu 250 illustrated in FIG. 2). The expanded application switcher menu 350 displays seven columns of application icons. According to various embodiments of the present disclosure, the application switcher menu 350 may include a tab 352 associated therewith. Selection of the tab 352 may toggle the application switcher 350 between an expanded and a collapsed state. For example, as illustrated in FIG. 3, the application switcher menu 350 is expanded. Accordingly, if tab 352 is selected, the application switcher menu 350 will be collapsed.

As illustrated in FIG. 3, the application switcher menu 320 is displayed at the bottom of the screen 310 (e.g., so as to form a horizontal row). The application switcher menu 320 includes a plurality of application icons 321a, 321b, 321b, 321c, 321d, 321e, 321f, and 321g. According to various embodiments of the present disclosure, the application switcher menu 320 may also have a tab 322 associated therewith. Selection of the tab 322 expands the application switcher menu 320. If the application switcher menu 320 is expanded, additional application icons corresponding to the category to which the application switcher menu 320 relates may be displayed if the category includes any additional application icons that are not displayed when the application switcher menu 320 is collapsed. For example, if the application switcher menu 320 is expanded (e.g., by selection of tab 322), the application switcher menu 350 may be automatically collapsed, or the expanded application switcher menu 320 may be displayed so as to be overlaid with the application switcher menu 350.

The application switcher menu 330 is displayed at the left of the screen 310 (e.g., so as to form a vertical column). The application switcher menu 330 includes a plurality of application icons 331a, 33b, 331c, and 331d. According to various embodiments of the present disclosure, the application switcher menu 330 may also have a tab 332 associated therewith. Selection of the tab 332 expands the application switcher menu 330. If the application switcher menu 330 is expanded, additional application icons corresponding to the category to which the application switcher menu 330 relates may be displayed if the category includes any additional application icons (or items) that are not displayed when the application switcher menu 330 is collapsed. For example, if the application switcher menu 330 is expanded (e.g., by selection of tab 332), the application switcher menu 350 may be automatically collapsed, or the expanded application switcher menu 330 may be displayed so as to be overlaid with the application switcher menu 350.

The application switcher menu 340 is displayed at the top of the screen 310 (e.g., so as to form a horizontal row). The application switcher menu 340 includes a plurality of application icons 341a, 341b, 341c, 341d, 341e, 341f, and 341g. According to various embodiments of the present disclosure, the application switcher menu 340 may also have a tab 342 associated therewith. Selection of the tab 342 expands the application switcher menu 340. If the application switcher menu 340 is expanded, additional application icons corresponding to the category to which the application switcher menu 340 relates may be displayed if the category includes any additional application icons (or items) that are not displayed when the application switcher menu 340 is collapsed. For example, if the application switcher menu 340 is expanded (e.g., by selection of tab 342), the application switcher menu 350 may be automatically collapsed, or the expanded application switcher menu 340 may be displayed so as to be overlaid with the application switcher menu 350.

The application switcher menu 350 is displayed at the right of the screen 310 (e.g., so as to form a vertical column) The application switcher menu 350 includes a plurality of application icons 351a, 351b, 351c, 351d, 351e, 351f, 351g, 351h, 351i, 351j, 351k, 351l, 351m, 351n, 351o, 351p, 351q, 351r, 351s, 351t, 351u, 351v, 351w, 351x, 351y, 351z, 351aa, 351ab. According to various embodiments of the present disclosure, the application switcher menu 350 may also have a tab (not shown) associated therewith. Selection of the tab may minimize or otherwise collapse the application switcher menu 350. If the application switcher menu 350 is collapsed, fewer application icons corresponding to the category to which the application switcher menu 350 relates may be displayed. For example, a single column of icons corresponding to the category to which the application switcher 350 relates may be displayed.

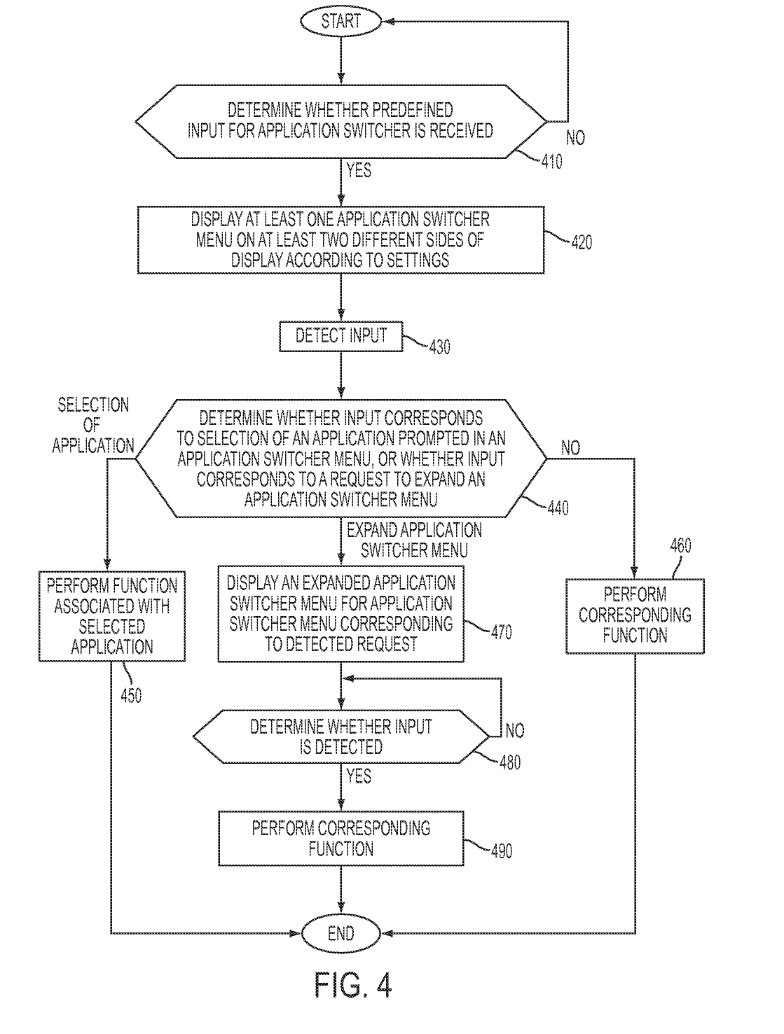

FIG. 4 is a flowchart illustrating a method for switching among applications operating on a mobile terminal according to various embodiments of the present disclosure.

Referring to FIG. 4, at operation 410, the mobile terminal may determine whether a predefined input to activate an application switcher functionality is received.

For example, the mobile terminal may determine whether an input set to display the application switcher menu is input. The input set to display the application switcher menu may correspond to a three-finger swipe down gesture on a touch screen, a selected gesture in the form of a letter, a shape, a number, and/or the like, selection of a physical button arranged on the mobile terminal, or the like.

If the mobile terminal determines that the predefined input to activate the application switcher functionality is not received at operation 410, then the mobile terminal may continue poll for input of the predefined input.

In contrast, if the mobile terminal determines that the predefined input to activate the application switcher functionality is received at operation 410, then the mobile terminal may proceed to operation 420 at which the mobile terminal displays at least one application switcher menu.

According to various embodiments of the present disclosure, the mobile terminal may display at least one application switcher menu on at least two different sides of the screen according to settings of the application switcher functionality. For example, according to various embodiments of the present disclosure, the application switcher functionality may be linked or otherwise associated with a user account, and the settings of the application switcher functionality may be configured by the user.

At operation 430, the mobile terminal detects an input.

At operation 440, the mobile terminal determines whether the detected input corresponds to selection of an application (e.g., selection of an application icon) provided in an application switcher menu, or whether the detected input corresponds to a request to expand an application switcher menu.

If the mobile terminal determines that the detected input does not correspond to selection of an application provided in an application switcher menu, and that the detected input does not correspond to a request to expand an application switcher menu at operation 440, then the mobile terminal performs a corresponding function.

In contrast, if the mobile terminal determines that the detected input corresponds to selection of an application provided in an application switcher menu at operation 440, then the mobile terminal proceeds to operation 450 at which the mobile terminal performs a function associated with the selected application. For example, the mobile terminal may load the application corresponding to the selected application. As another example, if the selected application corresponds to a short cut to a file (e.g., media file, word document, pdf, or the like), then the mobile terminal may load the corresponding file. Thereafter, the mobile terminal may end the process.

In contrast, if the mobile terminal determines that the detected input corresponds to a request to expand an application switcher menu at operation 440, then the mobile terminal proceeds to operation 470 at which the mobile terminal displays an expanded application switcher menu for the application switcher menu corresponding to the detected request. For example, with reference to FIGS. 2 and 3, if the input corresponds to selection of tab 252 associated with the application switcher menu 250 illustrated in FIG. 2, then the application switcher menu may be expanded, as illustrated in FIG. 3 in relation to application switcher menu 350. Thereafter, the mobile terminal proceeds to operation 480.

At operation 480, the mobile terminal determines whether an input is detected.

If the mobile terminal determines that an input is not detected at operation 480, then the mobile terminal may continue to poll for detection of an input.

In contrast, if the mobile terminal determines that an input is detected 480, then the mobile terminal may proceed to operation 490 at which the mobile terminal may perform a corresponding function. For example, if the input corresponds to terminating the application switcher functionality, then the mobile terminal may end display of the at least one application switcher menu. As another example, if the input corresponds to selection of an application (e.g., an application icon) included in the application switcher menu, then the mobile terminal may load the corresponding application.

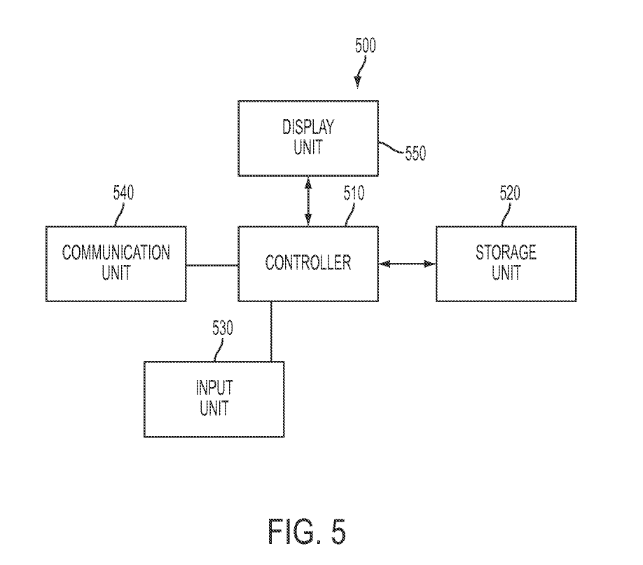

FIG. 5 is a block diagram schematically illustrating a configuration of a mobile terminal according to various embodiments of the present disclosure.

Referring to FIG. 5, a mobile terminal may include a control unit 510, a storage unit 520, an input unit 530, and a display unit 550. The mobile terminal may also include a communication unit 540.

According to various embodiments of the present disclosure, the mobile terminal 500 may be configured to selectively load an application switcher functionality. For example, the mobile terminal 500 may display at least one application switcher menu on a screen displayed by the display unit 550.

The storage unit 520 can store user data, and the like, as well a program which performs operating functions according to various embodiments of the present disclosure. For example, the storage unit 520 may store a program for controlling general operation of a mobile terminal 500, an Operating System (OS) which boots the mobile terminal 500, and application program for performing other optional functions such as a camera function, a sound replay function, an image or video replay function, a Near Field Communication (NFC) function, and/or the like. Further, the storage unit 520 may store user data generated according to a user of the mobile terminal 500, such as, for example, a text message, a game file, a music file, a movie file, and/or the like. In particular, according to various embodiments of the present disclosure, the storage unit 520 may store an application that enables a user to activate an application switcher functionality (e.g., so as to display at least one application switcher menu), to select an application icon provided in an application switcher menu, to expand an application switcher menu, to configure the application switcher functionality, and/or the like.

The input unit 530 may include input keys and function keys for receiving user input. For example, the input unit 530 may include input keys and function keys for receiving an input of numbers or various sets of letter information, setting various functions, and controlling functions of the mobile terminal 500. For example, the input unit 530 may include a calling key for requesting a voice call, a video call request key for requesting a video call, a termination key for requesting termination of a voice call or a video call, a volume key for adjusting output volume of an audio signal, a direction key, and the like. In particular, according to various embodiments of the present disclosure, the input unit 530 may transmit to the control unit 510 signals related to requesting activation of the application switcher functionality (e.g., display of the at least one application switcher menu); selection of an application icon from the at least one application switcher menu; selection to expand an application switcher menu, and/or the like. Such an input unit 530 may be formed by one or a combination of input means such as a touch pad, a touchscreen, a button-type key pad, a joystick, a wheel key, and/or the like.

The communication unit 540 may be configured for communicating with other devices, a communication network, and/or the like. For example, the communication unit 540 may be configured to communicate via Bluetooth technology, WiFi technology, and/or another wireless technology (e.g., CMDA, LTE, and/or the like). According to various embodiments of the present disclosure, the communication unit 540 may be configured to transmit/receive data relating to the application switcher functionality such as, for example, user account information, user settings, and/or the like using a through a wired connection such as, for example, a USB connection, a micro USB connection, a FireWire connection, a connection over a LAN, and/or the like. According to various embodiments of the present disclosure, the communication unit 540 may be configured to communicate with the terminal over a wireless connection such as, for example, Bluetooth, WiFi, Infrared communications, and/or the like.

The display unit 550 displays information inputted by user or information to be provided to user as well as various menus or user interfaces of the mobile terminal 500. For example, the display unit 550 may provide various screens according to a use of the mobile terminal 500, such as an idle screen, a message writing screen, a calling screen, and the like. The display unit 550 may display an interface which the user may manipulate or otherwise enter inputs via a touch screen to enter selection of activation of the application switcher functionality, selection of an application icon (e.g., so as to load an associated application), to expand an application switcher menu, and/or the like. The display unit 550 can be formed as a Liquid Crystal Display (LCD), an Organic Light Emitting Diode (OLED), an Active Matrix Organic Light Emitting Diode (AMOLED), and the like. However, various embodiments of the present disclosure are not limited to these examples. Further, the display unit 550 can perform the function of the input unit 530 if the display unit 550 is formed as a touch screen.

According to various embodiments of the present disclosure, the mobile terminal 500 comprises at least one control unit 510. The control unit 510 may be configured to operatively control the mobile terminal 500. For example, the control unit 510 may control operation of the various components or units included in the mobile terminal 500. The control unit 510 may transmit a signal to the various components included in the mobile terminal 500 and control a signal flow between internal blocks of the mobile terminal 500. In particular, according to various embodiments of the present disclosure, the control unit 510 can control configuration of the application switcher functionality settings. According to various embodiments of the present disclosure, the control unit 510 can control the mobile terminal 500 to display at least one application switcher menu. According to various embodiments of the present disclosure, the control unit 510 can control the mobile terminal 500 to expand and display at least one application switcher menu. For example, the control unit 510 may control the mobile terminal 500 to expand and display the at least one application switcher menu upon detection of a user input. According to various embodiments of the present disclosure, the control unit 510 can control the mobile terminal 500 to operate an application according to user selection. For example, the control unit 510 may detect a selection of an application icon displayed in an application switcher menu, and thereafter load or otherwise operate an application associated with the application icon.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for switching among applications, the method comprising:
detecting an input to activate an application switcher functionality;
upon detecting the input to activate the application switcher functionality, displaying at least one application switcher menu;
detecting an input corresponding to a request to expand one of the at least one application switcher menus; and
expanding the one of the at least one application switcher menus according to the detected request to expand the one of the at least one application switcher menus,
wherein each of the at least one application switcher menus includes at least one application icon associated with an application belonging to a category to which the application switcher menu relates.

2. The method of claim 1, wherein when the one of the at least one application switcher menus is expanded, the expanded application switcher menu has more application icons displayed therein than when the application switcher menu is not expanded.

3. The method of claim 1, wherein the displaying of the at least one application switcher menu comprises:
displaying a first application switcher menu along a first side of the screen; and
displaying a second application switcher menu along a second side of the screen.

4. The method of claim 3, wherein the category to which the first application switcher menu relates is different from the category to which the second application switcher menu relates.

5. The method of claim 4, wherein each of the first application switcher menu and the second application second switcher menu relates to one category of:
recently used;
recently downloaded;
favorites; and
frequently used.

6. The method of claim 1, wherein the displaying of the at least one application switcher menu comprises:
displaying a first application switcher menu along a bottom side of the screen;
displaying a second application switcher menu along a left side of the screen.
displaying a third application switcher menu along a top side of the screen; and
displaying a fourth application switcher menu along a right side of the screen.

7. The method of claim 6, wherein each of the categories to which each of the first application switcher menu, the second application switcher menu, the third application switcher menu, and the fourth application switcher menu relates is different.

8. The method of claim 7, wherein each of the first application switcher menu, the second application second switcher menu, the third application second switcher menu, and the fourth application second switcher menu relate to a category of:
recently used;
recently downloaded;
favorites; and
frequently used.

9. The method of claim 8, further comprising:
displaying a plurality of icons, each of the plurality of icons respectively associated with one of the first application switcher menu, the second application second switcher menu, the third application second switcher menu, and the fourth application second switcher menu,
wherein if one of the plurality of icons is selected, the one of first application switcher menu, the second application second switcher menu, the third application second switcher menu, and the fourth application second switcher menu which is associated with the selected icon is displayed so as to be expanded.

10. The method of claim 1, further comprising:
displaying at least one icon associated with each of the at least one application switcher menu,
wherein the detecting of an input corresponding to a request to expand one of the at least one application switcher menus comprises detecting selection of that at least one icon.

11. The method of claim 1, wherein a user may configure at least one of:
an arrangement of the at least one application switcher menu;
a number of application switcher menus that is displayed;
the category to which each application switcher menu relates; and
an input for activating display of the at least one application switcher menu.

12. A non-transitory computer-readable storage medium storing instructions that, when executed, cause at least one processor to perform the method of claim 1.

13. An apparatus for switching among applications, the apparatus comprising:
a display unit;
an input unit; and
a control unit configured to detect an input to the input unit to activate an application switcher functionality, to control the display unit to display, upon detection of the input to activate the application switcher functionality, at least one application switcher menu, to detect an input corresponding to a request to expand one of the at least one application switcher menus, and to control the display unit to display one of the application switcher menus in expanded form according to the detected expand the one of the at least one application switcher menus,
wherein each of the at least one application switcher menus includes at least one application icon associated with an application belonging to a category to which the application switcher menu relates.

14. The apparatus of claim 13, wherein when the one of the at least one application switcher menus is expanded, the expanded application switcher menu has more application icons displayed therein than when the application switcher menu is not expanded.

15. The apparatus of claim 13, wherein the display unit displays a first application switcher menu along one side of the screen, and a second application switcher menu along a second side of the screen.

16. The apparatus of claim 15, wherein the category to which the first application switcher menu relates is different from the category to which the second application switcher menu relates.

17. The apparatus of claim 16, wherein each of the first application switcher menu and the second application second switcher menu relates to one category of:
recently used;
recently downloaded;
favorites; and
frequently used.

18. The apparatus of claim 13, wherein the display unit displays a first application switcher menu along a bottom side of the screen, a second application switcher menu along a left side of the screen, a third application switcher menu along a top side of the screen, a fourth application switcher menu along a right side of the screen.

19. The apparatus of claim 18, wherein each of the categories to which each of the first application switcher menu, the second application switcher menu, the third application switcher menu, and the fourth application switcher menu relates is different.

20. The apparatus of claim 19, wherein each of the first application switcher menu, the second application second switcher menu, the third application second switcher menu, and the fourth application second switcher menu relate to a category of:
recently used;
recently downloaded;
favorites; and
frequently used.

21. The apparatus of claim 19, wherein the control unit is further configured to control the display unit to display a plurality of icons, each of the plurality of icons respectively associated with one of the first application switcher menu, the second application second switcher menu, the third application second switcher menu, and the fourth application second switcher menu, and
wherein if one of the plurality of icons is selected, the one of first application switcher menu, the second application second switcher menu, the third application second switcher menu, and the fourth application second switcher menu which is associated with the selected icon is displayed in expanded form.

22. The apparatus of claim 13, wherein the control unit is further configured to control the display unit to display at least one icon associated with each of the at least one application switcher menu, and to detect,
wherein selection of one of the at least one icon corresponds to the request to expand the corresponding one of the at least one application switcher menus.

23. The apparatus of claim 13, wherein a user may configure at least one of
an arrangement of the at least one application switcher menu;
a number of application switcher menus that is displayed;
the category to which each application switcher menu relates; and
an input for activating display of the at least one application switcher menu.
